(19) United States
(12) Patent Application Publication
(10) Pub. No.: US 2009/0013317 A1
(43) Pub. Date: Jan. 8, 2009

(54) Software Management for Software Defined Radio in a Distributed Network

(75) Inventors: Scott A. Abfalter, Melbourne, FL (US); Terry L. Williams, Melbourne Beach, FL (US); Thomas L. Jordan, Melbourne, FL (US); John J. Uberbacher, West Melbourne, FL (US)

Correspondence Address: SNELL & WILMER L.L.P. (Main), 400 EAST VAN BUREN, ONE ARIZONA CENTER, PHOENIX, AZ, 85004-2202, US

(73) Assignee: AIRNET COMMUNICATIONS CORPORATION, Melbourne, FL (US)

(21) Appl. No.: 11/772,487

(22) Filed: Jul. 2, 2007

Related U.S. Application Data
(63) Continuation of application No. 11/659,695, filed on Feb. 8, 2007.

(51) Int. Cl. G06F 9/44

(52) U.S. Cl. 717/170

(57) ABSTRACT

A method for installing software to software-defined radio equipment. The method includes the step of transferring software to one or more software-defined radio devices from a remotely located software server. The software server can be a computer operatively connected to the software-defined radio device via a communications network. The transferring step can occur while the software-defined radio device continues to perform software-defined radio functions. The software can be stored to a portion of a data store associated with the software-defined radio device which is not being used as a storage for currently running software. The software can be loaded on a restart of the software defined device. An error indication can be provided if a fault occurs in the transferring step or the loading step. The method also can include the step of reverting from the selected software to a previous software version upon a fault occurrence.

### CROSS REFERENCE TO RELATED APPLICATIONS

This application is a continuation of co-pending U.S. patent application Ser. No. 10/659,695 filed on Sep. 10, 2003. The aforementioned related patent application is herein incorporated by reference.

### BACKGROUND OF THE INVENTION

1. Statement of the Technical Field

The inventive arrangements relate to software defined radios, and more particularly to software management within software defined radio systems.

2. Description of the Related Art

A software defined radio (SDR) is a radio in which channel modulation waveforms are defined in software. In the transmit mode, waveforms are generated as sampled digital signals, converted from digital to analog via a wideband digital to analog converter (DAC), and then possibly unconverted from IF to RF. The receiver, similarly, employs a wideband analog to digital converter (ADC) that captures all of the channels of the software radio node. The receiver then extracts, downconverts and demodulates the channel waveform using software on a general purpose processor.

In contrast to hardware-defined radios for which upgrades require the replacement of radio hardware, an SDR can be upgraded merely by upgrading the software. Although software updates are much more cost effective as compared to replacement of radio hardware, installing new software upgrades can still be expensive and time consuming. This is particularly true in those instances where there are numerous SDR's that are installed over a distributed geographical area. Typically, a software installation requires that a technician visit each SDR location to perform the installation task. Further, the SDR usually needs to be taken offline during the software installation process. Notably, when the SDR is offline it is not generating any revenue.

Further, unforeseen problems are sometimes encountered when installing software. When such problems occur, it is often required that the newly added software be removed and a previous software version be reinstalled. Again, it generally is required that the SDR be taken offline to perform these tasks.

Oftentimes, operational aspects of a software defined radio system do not allow introduction of differing versions of software to individual SDR's. For example, this can be true where a plurality of SDR's are controlled by a common entity such as a base station controller in a Global System for Mobile Communications (GSM) network. To install new software in such systems, it is typically required that the network be taken offline while the install is performed on each of the SDR units. The task of performing multiple software installations can take a large amount of time. Hence, such software installations can be both time and cost prohibitive in view of the loss of revenue associated with the network being offline for an extended period of time.

Microsoft® Systems Management Server (MSMS) is a software product commercially available for distributing software over a network. MSMS provides an electronic distribution of software to ail desktop computers and servers on a network from a central location. Further, MSMS reports the status of software installations and operating system upgrades. MSMS, however, does not include functionality for automatically uninstalling such system upgrades should an error or incompatibility occur. Moreover, MSMS is compatible only with Microsoft Windows operating environments.

### SUMMARY OF THE INVENTION

The present invention relates to a method for installing software to software-defined radio equipment. The method includes the step of transferring software to one or more software-defined radio devices from a remotely located software server. The software server can be a computer operatively connected to the software-defined radio device via a communications network. The transferring step can occur while the software-defined radio device continues to perform software-defined radio functions. The software can foe stored to a portion of a data store associated with the software-defined radio device which is not being used as a storage for currently running software. For example, the software can be stored to a non-volatile second data store associated with the software-defined device.

The method also can include the step of transferring to the software-defined radio device a selection identifying at least one of the transferred software or the currently running software which is to be loaded by the software-defined radio device during a restart of the software-defined radio device, and loading the selected software. In one arrangement, the software can be transferred and loaded to a plurality of software-defined radio devices. The transferring step can be monitored and the loading step can be verified. An error indication can be provided if a fault is detected in the transferring step or the loading step. The method also can include the step of reverting from the selected software to a previous software version upon a fault detection.

The transferred software can include a plurality of software components. A version indicator which identifies software that is currently loaded on the software-defined radio device can be provided. A software listing identifying software currently available on the data store also can be provided. The version indicator and the software listing can be accessible from a remote location.

The present invention also includes a system for installing software to software-defined radio equipment. The system includes a software server for transferring software to one or more software-defined radio devices from a location remotely located with respect to the software-defined radio device. In particular, the software server can be a computer operatively connected to the software-defined radio device via a communications network.

The software can be transferred while the software-defined radio device continues to perform software-defined radio functions. The software server can include a compression application for compressing the software, which can include a plurality of software components, prior to the transfer. One or more non-volatile data stores can be associated with the software-defined radio device for storing the software. The software can be stored on a portion of a data store which is not being used to provide currently running software.

A man-machine interface or text-based user interface can be associated with the software server for receiving from a system operator a selection identifying at least one of the transferred software and the currently running software to be loaded at a next startup of the software-defined radio device. The man-machine interface also can include a version indicator identifying software which is currently loaded on the software-defined radio device and a software listing identifying software currently available on the storage associated with the software defined radio device.

The system also can include a processor. The processor can be programmed to load a selected one of the transferred software or the currently running software to the software-defined radio device during a restart of the device. The processor also can monitor the transferring of the software and loading of the transferred software and/or loading of the currently running software. Further, the processor can provide an error indication if a fault is detected in the transfer of the software or the loading of the software. If an error indication is generated, the processor can automatically revert from the transferred software to a previous software version upon the error indication being generated.

### BRIEF DESCRIPTION OF THE DRAWINGS

FIG. 1 shows a block diagram illustrating a generic system for remotely installing software to software defined radio (SDR) devices which is useful for understanding the present invention.

FIG. 2 shows a block diagram illustrating a typical system for remotely installing software to software defined radio (SDR) devices which is useful for understanding the present invention.

FIG. 3 is a flowchart that is useful for understanding a method of remotely installing software to software defined radio devices.

### DETAILED DESCRIPTION OF THE PREFERRED EMBODIMENTS

The present invention relates to a method for installing new software to software-defined radio equipment that may already have installed a prior software version. The software can be transferred to a software-defined radio (SDR) device from a software server which can be remotely located with respect to the SDR device. The new software can be stored to a portion of a data store associated with the SDR device which is not being used as a storage for a currently running prior software version. Accordingly, the prior software version can be left intact and operational while the new software is instantiated during a restart of the SDR device. Because the prior version is left intact, the SDR device can revert to the prior version should a problem be encountered with the new software.

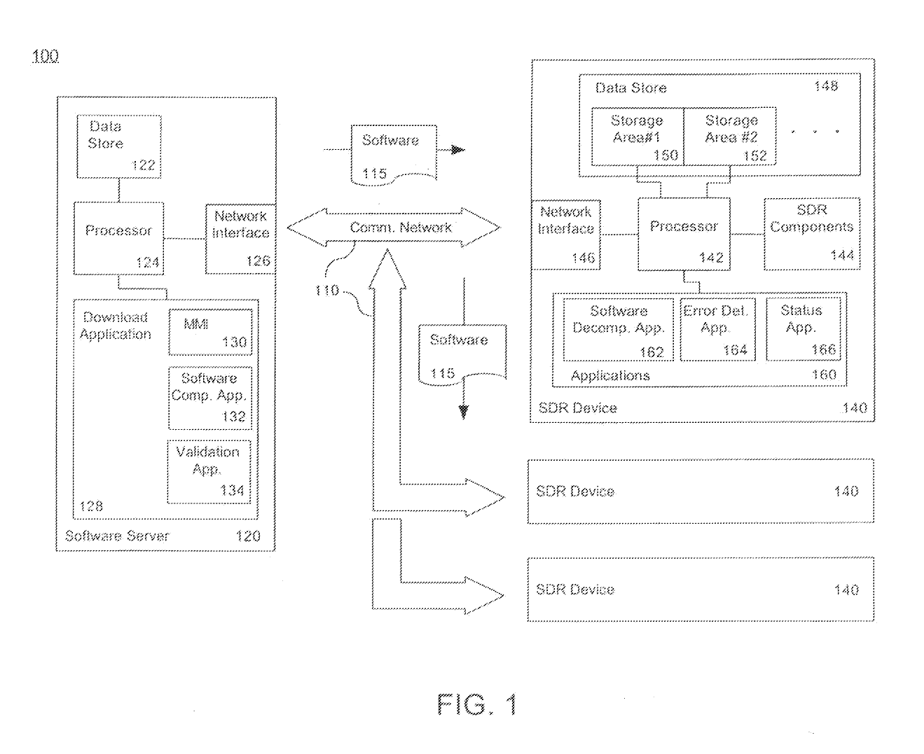

Referring to FIG. 1, a block diagram is shown that is useful for understanding the present invention. The block diagram illustrates an exemplary system 100 for installing software 115 to SDR devices 140 from a remote location. The exemplary system 100 can include a software server 120 communicatively connected to one or more SDR devices 140. The software server 120 can be connected to the SDR devices 140 via a communications network 110, for example a wireless communication network, a local area network (LAN), a wide area network (WAN), a public switched telephone network (PSTN), a public switched packet network (PSPN), the Internet, or any other communication network, or combination of communication networks. In one arrangement, the software server 120 can be operatively connected to the SDR devices 140 via a cellular communication network, such as a global system for communications (GSM) network.

The software server 120 can be any system which can transfer software 115 to one or more SDR devices 140. The software server 120 can comprise a data store 122, a processor 124, a network interface 126, and software applications, such as a download application 128. For instance, the software server 120 can be a computer system. Importantly, the software server 120 is not limited to any particular type of computer system. Rather, any one of a number of known types of systems can be used. For example, the software server 120 can be a workstation, a file server, a network server, or any other system capable of providing data across the communications network.

The network interface 126 can be a modern, a bus interface, an Ethernet, network adapter, a wireless network adapter, or any other type of network interface which can be used by the software server 120 in communicating over a communications network.

The data store 122 can be any storage which can store software. For instance, the data store can comprise battery backed random access memory (RAM), flash memory, a magnetic storage medium, an optical data store, a magneto-optical data store, or any other data store which can store digital or analog data. For example, the data store can be an electrically erasable programmable read-only memory (EEPROM), a hard disk drive (HDD), a magnetic tape, a floppy disk, a CD-ROM, a CD-RW, a magneto-optical drive, and so on.

In one arrangement, software which is to be distributed to the SDR devices 140 can first be loaded to the data store 122 of the software server via file transfer protocol (FTP), CD-ROM, or any other desired means. From this point the software can be available for distribution to the SDR devices 140 using the software download application 128. Notably, one or more systems can be used for data storage and distribution. For example, the software can be stored on a system that is managing software distribution. In an alternate example, the software can fee stored on a first system and a second system can be used for managing the software distribution.

The software download application 128 can comprise a man-machine interface (MMI) 130, a software compression application 132, and a software validation application 134. The MMI 130 can be provided with the software download application 128 to facilitate interaction with a system operator. For example, the MMI can be a graphical user interface (GUI) or a text-based user interface. The MMI 130 can provide a navigation tree for viewing and managing software on multiple SDR devices 140. GUI's and text-based user interfaces are well known to the skilled artisan.

The software compression application 132 can compress the software 115 prior to transferring the software 115 to the SDR devices 140. Software compression applications are known to the skilled artisan.

Further, the validation application 134 can validate software 115 after it is downloaded to insure that the download has been completed successfully. After a download has been completed, validation software can perform a check of the software 115 to insure that the software 115 downloaded correctly and that the software 115 is stored in a usable format, for example after being decompressed. The validation can include a process wherein the validation software causes the SDR device to calculate the checksum or cyclic redundancy check (CRC) for the downloaded software 115. The checksum or CRC then can be reported back to the validation software, which can compare the checksum or CRC to a stored value corresponding to the software that was downloaded. If the values do not match, the download application can present an error message to the system operator and/or automatically reinitiate download. The implementation of checksum and CRC is known to the skilled artisan.

The SDR devices 140 can be SDR systems or other SDR equipment having SDR components. For example, an SDR device 140 can be an SDR base transceiver station (BTS), an SDR basestation controller (BSC), an SDR radio, an SDR transcoder/rate adaptor unit (TRAU), or any other SDR equipment that utilizes software and/or updatable firmware during operation. An exemplary SDR device 140 can include a processor 142 for controlling SDR components 144. The SDR components 144 can be any components within an SDR device 140 which have at least some level of software control. For instance, an SDR component can be a transceiver, channelizer/combiner, power amplifier, or any other software controlled equipment.

The SDR device 140 also can include a network interface 146 for receiving the software 115 from the software server 120 over the communications network. Again, the network interface 146 is not limited to any type of network interface, but can be any network interface which enables the SDR device 140 to communicate over a communications network. For example, the network interface 146 can be a modem, a bus interface, an Ethernet network adapter, a wireless network adapter, or any other type of network interface which can be used to by the SDR device 140 in communicating over a communications network. Importantly, the use of an existing network interface which communicates over an existing communications network can minimize deployment cost. For example, if the SDR device 140 is operatively connected to a GSM network, the GSM network can be used to transfer the software 115. In another arrangement, if the SDR device 140 is operatively connected to a backhaul communication link, the backhaul communication fink can be used to transfer the software 115. Still, other types of communication links can be used to transfer the software 115 and the invention is not so limited.

The SDR device 140 further can include at least one non-volatile data store 148. The data store 148 can comprise any of a number of storage devices. For instance, the data store can comprise flash memory, a magnetic storage medium, an optical data store, a magneto-optical data store, or any other data store which can store digital or analog data. For example, the data store can be an electrically erasable programmable read-only memory (EEPROM), a hard disk drive (HDD), a magnetic tape, a floppy disk, a CD-ROM, a CD-RW, a magneto-optical drive, and so on.

In a preferred arrangement, two or more data store areas 150, 152 are provided. Accordingly, new software can be transferred to a second data store area 152 without overriding software contained in a first data store area 150. The data store areas 150, 152 can be distinct storage areas on single data store 148, for example separate partitions on a HDD. Alternatively, each data store area 150, 152 can be contained on a different data store. For example, a first EEPROM can be provided for data store 150 and a second EEPROM can be provided for data store 152.

Further, the SDR device 140 can include a decompression application 162. The decompression application can be utilized for decompressing the software 115 if the software is received from the software server 120 in a compressed format. Decompression applications are known to those skilled In the art and are commercially available.

In operation, the software server 120 can provide software 115 to one or more SDR devices 140 over the communications network. Advantageously, the software 115 can be simultaneously installed to multiple SDR devices 140. Accordingly, the expense of installing or upgrading software to the SDR devices 140 can be minimized because a technician would not be required to travel to each SDR device location to perform the software installation or upgrade. Moreover, downtime of an SDR system resulting from the software installations or upgrades would be minimized as compared to an SDR system in which software installations or upgrades are performed sequentially.

The software 115 can be any type of software which can run on an SDR device. For example, the software can be an operating system or an executable application. Moreover, the software 115 can comprise a software patch, a portion of an executable application which can be incorporated info the application, a file, or any other type of software which can be used to update an SDR device 140.

As noted, the software 115 can be stored to a data store area associated with each SDR device 140 which is not being used to store currently running software. Accordingly, a replacement version of the software can be stored and/or staged for implementation without interrupting operation of a preceding version and without impacting the services provided by the SDR device 140. The SDR device 140 then can halt operation of the preceding version of the software and begin operating with the replacement version of the software whenever it is desired to do so. For example, the SDR device 140 can begin using the replacement version of the software on a next scheduled restart of the SDR device 140. Such a restart can be a normally scheduled restart, or a restart scheduled to occur at any other time. In one arrangement, restarts or reinitializations can be scheduled and/or triggered remotely from the software server 120 as part of normally scheduled maintenance or as a system operator initiated operation.

The preceding version of the software can be left Intact in the first data store area 150 and should not be overwritten. Accordingly, the SDR device 140 can revert back to the preceding version of the software when it is desirable to do so. For example, the SDR device 140 can quickly revert to the preceding version of the software if an error is encountered with the replacement version. In a preferred arrangement, the reversion is an automatic process that can take place should certain error conditions exist. For instance, if a software error is encountered which causes the SDR device 140 to stop functioning properly, the SDR device 140 can be predisposed to shutdown and restart, reloading the preceding version of the software either during or after the restart. A restart application, for example, can fee provided with the SDR device 140. In another arrangement, a software version to be run at the next startup of the SDR device 140 can be pre-selected by a system operator. The pre-selected version then can be used when the SDR device is restarted for any reason, for instance due to an automatically scheduled restart, a manual restart, fault recovery, a power cycle, and so on.

In the case that the files or configuration data must be updated to revert back to the preceding version of the software, such updates can also be automatically executed. For example, an uninstall application can be provided on the SDR device 140 to uninstall software as required and revert back to a previous software version.

A backup copy of the replacement version of the software 115 also can be stored to the data store. Thus, if the replacement version of the software 115 were to be corrupted at runtime, the runtime copy can be replaced with a fresh copy of the software. Again, the replacement of the runtime software can be automatically executed upon detection of the runtime error.

An error detection application 164 can be provided on the SDR device 140 to monitor the software 115 and/or hardware in the SDR device 140. The error detection application 164 can generate an error signal if a fault is detected. For example, an error signal can be generated if the software were to stop responding to data inputs, if a predetermined time out condition for a response has been exceeded, if the software were to provide any other indication that the software 116 is not operating within normal parameters, or any other type of software/hardware error were to occur. The error detection application 164 can interface with the restart application to trigger a restart of the SDR device 140. Further, the error detection application 164 can interface with the uninstall application to initiate an uninstall of a particular software version if a fault is detected.

In yet another arrangement, a version of the software which is loaded on restart can depend on the error which is defected. For example, if a particular error signal is predefined as being associated with a software/hardware incompatibility, a previous version of the software can be loaded on the next restart. Specifically, the current version initialization can be aborted and initialization parameters can be set to a previous state which causes the previous software version to be loaded on the next restart. However, if the error is not so predefined, the current version of the software can be re-loaded on the restart. If after a predefined number of attempts, for instance 2, the software cannot be successfully loaded, the restart application can trigger the previous software version to be loaded. Error detection and restart procedures are known to those skilled in the art. For example, a CRC can be performed on the software to generate a CRC value which can be compared to a stored value corresponding to the software, as previously described.

The software download application 128 on the software server 120 can communicate with the SDR device 140 to identify current running software and/or staged versions of software on the SDR device 140. For example, any of a variety of communication pathways through the communications network can be provided to exchange messages between the download application 128 and the SDR device 140. For example, in one embodiment, the software download application 128 can send a message to the SDR device 140 requesting status information of the SDR device 140. A status application 166 operating on the SDR device 140 can provide variables relating to the status of the SDR device 140. The status application 166 can utilize the processor 142 to poll the data store 148, cache memory (not shown), and/or random access memory (RAM) to identify currently running software information, such as version information, identify staged versions of the software, identify versions of the software which are stored in the data store 148, or identify any other desired parameters.

The status information can fee presented to the system operator via the MMI 130. For example, the MMI 130 can show a listing of software currently stored on the data store 148, including software version information. The MMI 130 also can show currently installed software patches and which software is currently running on the SDR device 140. Further, information relating to what software versions are staged to be loaded on a next restart can be provided by the MMI 130. Accordingly, the system operator can evaluate the current status of the SDR device 140. For instance, if a SDR device 140 has not been updated with the latest version of a particular software, but the version which is installed on the SDR device 140 is satisfactory for that particular SDR device, a system operator may decide not to install a new version of the software.

In an alternate arrangement, log entries can be automatically generated by a logging application residing on the SDR device 140. For example, the logging application can receive error messages from the error detection application 164 and create a log entry each time an error is detected. The logging application also can receive signals from the operating system of the SDR device 140 each time software is loaded on the SDR device 140, or each time software 115 is transferred to, installed on, or uninstalled from the SDR device 140. Log entries can be generated by the logging application each time such a signal is received.

The SDR device 140 can evaluate log entries to provide a version indicator which is accessible by the software server, or other systems remotely located with respect to the SDR device 140. Further, the SDR device 140 can provide to the software server log entries associated with the SDR device 140. Error information contained in the log also can be presented to the system operator via the MMI 130. The errors can be evaluated by the system operator when troubleshooting the SDR device 140.

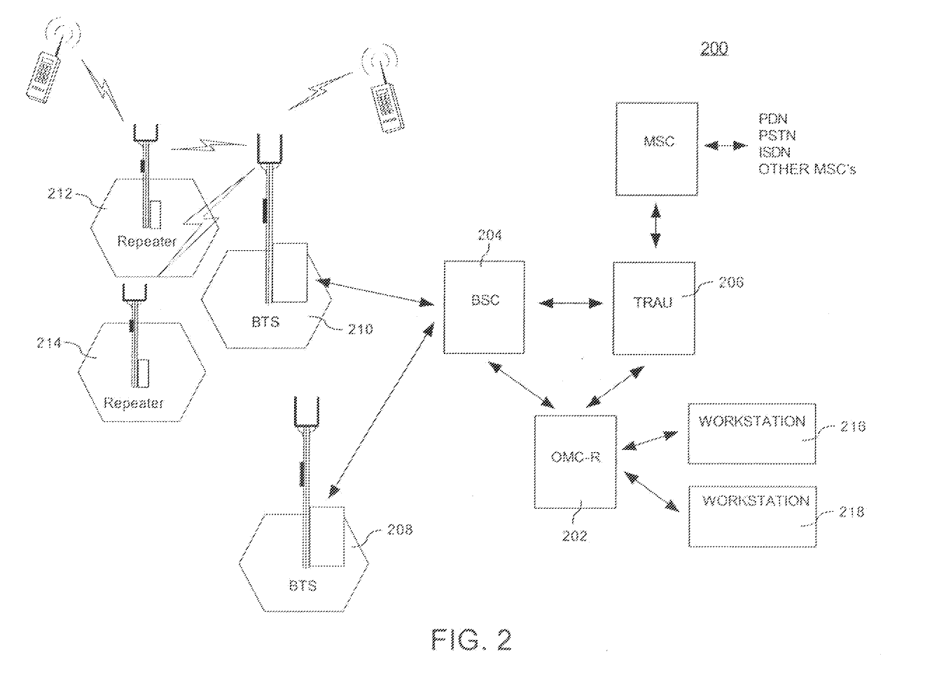

Referring to FIG. 2, a block diagram 200 is shown which illustrates an alternative system for remotely installing software to SDR devices in a cellular communications network. An operation and maintenance center-radio (OMC-R) 202 can be provided to distribute software to the SDR devices, for example an SDR basestation controller (BSC) 204, an SDR transcoder/rate adaptor unit (TRAU) 206, SDR base transceiver stations (BTS's) 208, 210, repeaters 212, 214, and other SDR devices. The OMC-R is a network management system responsible for the operation and maintenance of SDR devices. For example, the OMC-R can be a computerized system incorporating SDR network management software. In a preferred arrangement, the OMC-R provides a MMI for providing information to, and receiving commands from, a system operator. The OMC-R can be accessed directly by a system operator, or from a workstation 216, 218 or terminal (not shown). U.S. Pat. No. 6,253,060 to Komara, et al. provides an overview of such cellular communication systems and is incorporated herein by reference.

In operation, the OMC-R 202 can be communicatively linked to the BSC 204 and/or the TRAU 206 via a data communications link, for example, T-1, ISDN, frame relay, DSL, and so on. Accordingly, the OMC-R 202 can provide software downloads directly to the BSC 204 and TRAU 206. In one arrangement, the OMC-R 202 can communicate with the BSC 204 and TRAU 206 using a link access protocol on the D channel (LAP-D) of an ISDN line. LAP-D is a Layer 2 protocol which is defined in the International Telecommunications Union-Telecommunication Standardization Sector (ITU-T) recommendations Q.920 and Q.921. Still, other communication protocols can be used and the invention is not so limited. Further, the OMC-R can provide software downloads to the BTS's 208, 210 via the BSC 204. For instance, the software downloads can be routed to BTS's 208, 210 via the BSC 204 using the LAP-D protocol, or any other suitable protocol.

The OMC-R also can provide downloads to the repeaters 212, 214. For instance, the software downloads can be routed to the repeaters 212, 214 via the BSC 204 and the BTS 210. For example, LAP-D can be used to route the software to the BTS 210, which then can wirelessly transfer the software downloads to the repeaters 212, 214. The BTS 210 can transfer the software downloads to the repeaters 212, 214 using time division multi access (TDMA), code division multiple access (CDMA), pulse code modulation (PCM), spatial division multiple access (SDMA), or any other suitable protocol. In one arrangement, the software downloads can be parsed into data blocks and wirelessly transmitted to the repeaters 212, 214. A validation can be performed on each data block, for example using the checksum technique. Data blocks which are found to be corrupted can be replaced. The use of data blocks to transmit data is known to the skilled artisan.

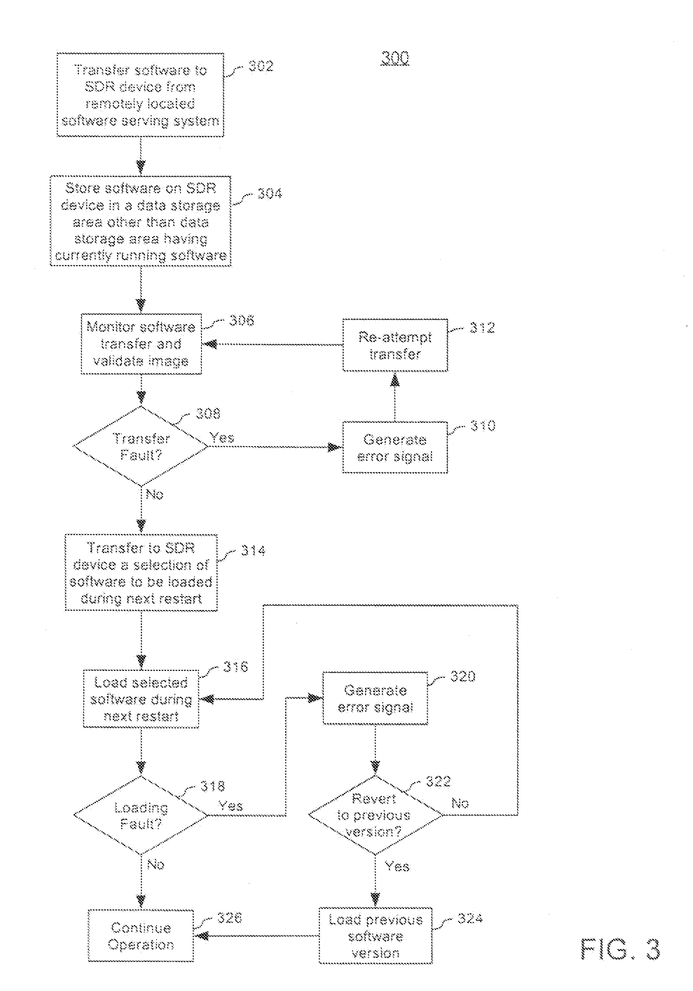

Referring to FIG. 3, a flowchart 300 is presented that is useful for understanding a method of remotely installing software to software defined radio devices. Referring to step 302, software can be transferred to the SDR device from a remotely located software server using a software download application. In step 304, the software can be stored on the SDR device in a data store area that is different from the data store area having the currently running software. Proceeding to step 306, the software transfer can be monitored by the software download application and an image of the software created by the software transfer can be validated, as previously described. Monitoring of the software transfer and the validation can be performed by an application running on the software server and communicating with the SDR device, or performed by an application running on the SDR device.

If a transfer fault occurs and/or the image of the software is corrupted, an error signal can be generated as shown in decision box 308 and step 310. The transfer can again be attempted and the re-attempt can be monitored, as shown in step 312 and step 206. In one arrangement, the software server can monitor the number of transfer attempts and halt the transfer attempts after a predefined number of transfer faults have occurred,

Proceeding to step 314, a system operator using an software server can select a version of software to be loaded during a next restart of the SDR device. The selection of the system operator can be transferred from the software server to the SDR device. The SDR device can load the selected software accordingly during a next restart of the SDR device, as shown in steps 314 and 316. A system restart application can be provided on the SDR device for processing the system operator selection and implementing the selection on a next SDR device restart.

The step of loading the selected software can be verified, for example by a software application suitable for performing such verification. If a fault is encountered during loading of the selected software, an error signal can be generated, as shown in decision box 318 and step 320. The SDR device can again attempt to load the selected software version, as shown in decision block 322 and step 316, or the SDR device can automatically revert to a previous version of the software, as shown in decision box 322 and step 324. For example, the SDR device can be predisposed to attempt to load the selected software version a fixed number of times, for example twice. After the fixed number of attempts to load the selected software have failed, the SDR device then can load a previous version of the software. Proceeding to step 326, the SDR device then can continue operation.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

1. A method for installing software to software-defined radio equipment comprising the steps of:
transferring software to a software-defined radio device from a software server, said software server remotely located with respect to said software-defined radio device;
storing said software to a portion of a data store associated with said software-defined radio device, said portion of said data store not being used as a storage for currently running software; and
loading at least one of said transferred software and said currently running software to said software-defined radio device during a restart of said software-defined radio device.

2. The method according to claim 1, further comprising the step of automatically reverting from said selected software to a previous software version upon a fault detection.

3. The method according to claim 1, further comprising the step of monitoring said transferring and loading steps.

4. The method according to claim 1, further comprising the step of transferring to said software-defined radio device a selection identifying software to be loaded by said software-defined radio device during a restart of said software-defined radio device.

5. The method according to claim 4, wherein said selection identifies at least one of said transferred software and said currently running software.

6. The method according to claim 4, wherein said selection identifies a software version.

7. The method according to claim 1, further comprising the steps of:
transferring said transferred software to at least a second software-defined radio device; and
consecutive with said loading step, loading said transferred software to said second software-defined radio device.

8. The method according to claim 1, further comprising the step of providing an error indication if a fault is detected In at least one of said transferring step and said loading step.

9. The method according to claim 1, wherein said transferred software comprises a plurality of software components.

10. The method according to claim 1, further comprising the step of providing a version indicator accessible from a remote location, said version indicator identifying software which is currently loaded on said software-defined radio device.

11. The method according to claim 1, further comprising the step of providing a software listing accessible from a remote location, said software listing identifying software currently available on said data store.

12. The method according to claim 1, wherein said storing step comprises storing said transferred software to a second data store associated with said software-defined device.

13. The method according to claim 12, wherein said second data store is non-volatile.

14. The method according to claim 1, wherein said transferring step occurs while said software-defined radio device continues to perform software-defined radio functions.

15. The method according to claim 1, wherein said software server is a computer operatively connected to said software-defined radio device via a communications network.

16. A method for installing software to software-defined radio equipment comprising the steps of:
receiving to a software-defined radio device software from a software server, said software server remotely located with respect to said software-defined radio device;
storing said software to a portion of a data store associated with said software-defined radio device, said portion of said data store not being used as a storage for currently running software;
receiving to said software-defined radio device a selection identifying at least one of said transferred software and said currently running software to be loaded by said software-defined radio device during a restart of said software-defined radio device;
loading said at least one of said transferred software and said currently running software; and
verifying said loading step.

17. The method according to claim 16, further comprising the step of automatically reverting from said at least one of said transferred software and said currently running software to a previous software version upon a fault being detected in said loading step.

18. The method according to claim 16, further comprising the step of providing an error indication upon said fault detection.

19. The method according to claim 16, further comprising the steps of:
monitoring said receiving step; and
providing an error indication if a fault is defected in said receiving step.

20. The method according to claim 16, further comprising the step of providing a version indicator accessible from a remote location, said version indicator identifying software which is currently loaded on said software-defined radio device.

21. The method according to claim 16, wherein said selection identifies a software version.

22. The method according to claim 16, further comprising the step of providing a software listing which is accessible from a remote location, said software listing identifying software currently available on said data store.

23. The method according to claim 16, wherein said storing step comprises storing said transferred software to a second data store associated with said software-defined device.

24. The method according to claim 23, wherein said second data store is non-volatile.

25. The method according to claim 16, further comprising the step of decompressing said transferred software after said receiving step.

26. The method according to claim 16, wherein said receiving step occurs while said software-defined radio device continues to perform software-defined radio functions.

27. A system for installing software to software-defined radio equipment comprising:
a software server for transferring software to a software-defined radio device from a location remotely located with respect to said software-defined radio device;
a man-machine interface associated with said software server for receiving from a system operator a selection identifying at least one of said transferred software and said currently running software to be loaded at a next startup of said software-defined radio device;
a data store associated with said software-defined radio device for storing said software, said software stored on a portion of said data store which is not being used to provide currently running software; and
a processor programmed to;
load a selected one of said transferred software and said currently running software to said software-defined radio device during a restart of said software-defined radio device;
provide an error indication if a fault occurs in at least one of said transfer of said software and said loading of said software; and
automatically reverting from said transferred software to a previous software version upon said error indication being generated.

28. The system according to claim 27, wherein said processor is further programmed to monitor said transferring of said software, and loading of said selected software.

29. The system according to claim 27, wherein said software server transfers said transferred software to at least a second software-defined radio device, wherein said transferred software is consecutively loaded on said software-defined radio device and on said second software-defined radio device.

30. The system according to claim 27, wherein said software server further comprises a compression application for compressing said software prior to said software being transferred.

31. The system according to claim 27, wherein said transferred software comprises a plurality of software components.

32. The system according to claim 27, wherein said man-machine interface further comprises a version indicator, said version indicator Identifying software which is currently loaded on said software-defined radio device.

33. The system according to claim 27, wherein said man-machine interface provides a software listing identifying software currently available on said data store.

34. The system according to claim 27, further comprising a second data store associated with said software-defined device for storing said transferred software.

35. The system according to claim 34, wherein said second data store is non-volatile.

36. The system according to claim 27, wherein said software is transferred to said software-defined radio device while said software-defined radio device continues to perform software-defined radio functions.

37. The method according to claim 27, wherein said software server is a computer operatively connected to said software-defined radio device via a communications network.
